(19) United States
(12) Patent Application Publication
(10) Pub. No.: US 2017/0190933 A1
(43) Pub. Date: Jul. 6, 2017

(54) SURFACE MODIFICATION TREATMENT AGENT, MEMBER FOR IMAGE FORMING APPARATUS AND TONER FIXING MECHANISM

(71) Applicants: NOK Corporation, Tokyo (JP); Synztec Co., Ltd., Tokyo (JP)

(72) Inventors: Toshihiro HIGASHIRA, Kanagawa (JP); Atsushi IKEDA, Kanagawa (JP)

(73) Assignees: NOK Corporation, Tokyo (JP); Synztec Co., Ltd., Tokyo (JP)

(21) Appl. No.: 15/325,321

(22) PCT Filed: Jul. 7, 2015
(86) PCT No.: PCT/JP2015/069484

§ 371 Date: Jan. 10, 2017

(30) Foreign Application Priority Data
Jul. 10, 2014 (JP) 2014-142693

(51) Int. Cl. B32B 9/04; C09D 183/06; G03G 15/20

(52) U.S. Cl. CPC C09D 183/06; G03G 15/2089

(57) ABSTRACT

An object of the present invention is to provide a surface modification treatment agent capable of achieving lower tackiness and lower friction, a member for an image forming apparatus and a toner fixing mechanism. The object can be fulfilled by a surface modification treatment agent including: (A) an alkoxyoligomer; (B) (1) a long-chain silicone oil whose viscosity is within the range of 50 cSt to 500,000 cSt, or (2) at least one type of silicone oil selected from a carbinol-modified silicone oil, a carboxyl-modified silicone oil, a polyether-modified silicone oil, and a fluoroalkyl-modified silicone oil, whose one or both terminals and/or a side chain include a functional organic group introduced; and (C) an organotitanium compound or an organoaluminum compound; a member for an image forming apparatus, the surface of the member being modified with the above surface modification treatment agent; and a toner fixing mechanism including: a pressing roller 1 corresponding to the member for an image forming apparatus; a fixing belt 3; and a heating roller 2, in which the pressing roller 1 is disposed so as to be brought into contact with the heating roller 2 through the fixing belt 3.

### TECHNICAL FIELD

The present invention relates to a surface modification treatment agent, a member for an image forming apparatus and a toner fixing mechanism, and particularly a surface modification treatment agent capable of achieving lower tackiness and lower friction, a member for an image forming apparatus and a toner fixing mechanism.

### BACKGROUND

One recent type of developing device includes a non-magnetic one-component developing system. In the process of development, the system is known to be a contact developing system. This developing system allows a developing roll with a toner (developer) adhered thereon to uniformly contact with pressure on a photoreceptor.

Generally, electrostatic latent image means forms electrostatic latent images on the surface of a photoconductive drum based on predetermined image information. On the other hand, a toner supply roller provides a toner to the surface of a developing roll. Subsequently, a member for regulating the amount of a developer (also referred to as “regulating blade”) controls the thickness of the toner provided on the developing roll to make it uniform. Accordingly, a thin layer of the toner is uniformly formed on the surface of the developing roll.

Afterward, the developing roll having the thin layer of the toner formed on the surface successively adheres a toner to the electrostatic latent images formed on a photoconductive drum at a nip portion or a proximity portion with the photoconductive drum.

The toner on the photoconductive drum is transferred to the paper, and then a fixing roller melts and fixes the toner on the paper with heat and pressure to develop the toner.

A toner fixing portion commonly includes a structure for sandwiching the paper between a pressure roller and a fixing pad through a fixing belt. A conventional method is to heat a fixing belt with radial heat from a halogen heater.

Unfortunately, this conventional method requires a larger size of the heater itself.

To solve the above-mentioned problems, a structure for sandwiching a fixing belt between a heating roller and a pressing roller just before feeding paper and then pressurizing and directly heating a film belt itself has been proposed.

The above structure allows for a smaller heating mechanism of a fixing belt, resulting in reduced power for heating and elevated heating rates.

Despite these advantages, the structure is prone to accumulation of a residual toner on a pressing roller after the toner moves from the surface of a fixing belt. It is thus desirable that by making the surface of the pressing roller non-tackier than the fixing belt, molten residual toner be adhered to the fixing belt to prevent accumulation of the toner on the pressing roller.

To make the surface of the pressing roller non-tackier than the fixing belt, the coefficient of wear is required to be not more than a predetermined value.

Generally, a method for treating the surface with a surface modification treatment agent is known to obtain desired physical properties concerning the surface of a roller.

For example, Patent Document 1 proposes a method for forming a top layer on the surface of an elastic rubber layer, and a technology for modifying the surface of the elastic rubber layer. With reference to Example 16 of Patent Document 1 (see paragraph [0076]), an elastic rubber layer development roller A is immersed with a surface modification treatment agent at normal temperature for 10 minutes, and then allowed to stand for 24 hours under a normal-temperature and normal-humidity condition. Accordingly, a technology for subsequently curing a silicone alkoxyoligomer to produce a development roller B with higher hardness in the proximity of the surface of the elastic rubber layer is disclosed. The surface modification treatment agent employed is a surface modification treatment agent prepared by dissolving 2 parts by mass of a silicone alkoxyoligomer (“KR-500,” Product from Shin-Etsu Chemical Co., Ltd.) and 0.08 parts by mass of a curing catalyst of a silicone alkoxyoligomer (“D-20,” Product from Shin-Etsu Chemical Co., Ltd.) into the total 100 parts by mass of an n-hexane.

However, such a development roller unfortunately causes higher coefficient of dynamic friction, and fails to achieve lower tackiness and lower friction.

A method in the art is to coat a base material with a surface modification treatment agent containing PTFE (polytetrafluoroethylene) particles in large quantities to reduce the coefficient of friction (Patent Document 2). However, this method has several drawbacks: falling of PTFE particles; generation of irregularities; and decreased adhesion with a base material. Irregularities on the surface can generate stain, a resin melt and paint, all of which may be adhered to recesses. These substances, once adhered, cannot be totally removed.

A step for generating no irregularities may include a method for forming a film by coating the film with PTFE or PFA (4-ethylene fluoride-perfluoroalkoxyethylene copolymer) powder, or PTFE or PFA aqueous dispersion, and melting the same at 300° C. or more. In fact, this method makes it difficult to determine the coefficient of friction under a predetermined value, resulting in insufficient non-tackiness.

Similarly, the above disadvantage is found for a silicone resin coating. A method for adding oil for surface lubrication and lower friction is employed, but this method is prone to degraded adhesion with a base material, transfer of oil bleeding on the surface to the counterpart surface, removal of oil by brushing, and loss of lubrication by a reciprocating motion.

### PRIOR ART DOCUMENTS

### Patent Documents

Patent Document 1: JP-B-5396540
Patent Document 2: JP-A-2004-138743

### SUMMARY OF THE INVENTION

### Problem to be Solved by the Invention

It is an object of the present invention to provide a surface modification treatment agent capable of achieving lower tackiness and lower friction, a member for an image forming apparatus and a toner fixing mechanism.

Other problems with the present invention will obviously be disclosed.

### Means for Solving Problem

The above problems will be solved by each of the following items.

1. A surface modification treatment agent comprising:
(A) an alkoxyoligomer;
(B) (1) a long-chain silicone oil whose viscosity is within the range of 50 cSt to 500,000 cSt, or
(2) at least one type of silicone oil selected from acarbinol-modified silicone oil, a carboxyl-modified silicone oil, a polyether-modified silicone oil, and a fluoroalkyl-modified silicone oil, whose one or both terminals and/or a side chain include a functional organic group introduced; and
(C) an organotitanium compound or an organoaluminum compound.

2. A member for an image forming apparatus, the surface of the member being modified with the surface modification treatment agent according to 1.

3. The member for an image forming apparatus according to 2, wherein the coefficient of friction is 0.15 or less.

4. The member for an image forming apparatus according to 2 or 3, wherein the member for an image forming apparatus is a pressing roller.

5. A toner fixing mechanism, comprising: the pressing roller according to 4; a fixing belt; and a heating roller, wherein the pressing roller is disposed so as to be brought into contact with the heating roller through the fixing belt.

### Effect of the Invention

The present invention can provide a surface modification treatment agent capable of achieving lower tackiness and lower friction, a member for an image forming apparatus and a toner fixing mechanism.

### BRIEF DESCRIPTION OF THE DRAWINGS

FIG. 1 is a cross-sectional view showing one example of main parts of a pressing roller in a toner fixing mechanism used in the present invention.

FIG. 2 is a schematic diagram showing one example of a developing device by means of a member for an image forming apparatus of the present invention.

### DESCRIPTION OF THE PREFERRED EMBODIMENTS

Preferred embodiments of the present invention will be described.

1. Surface Modification Treatment Agent

The surface modification treatment agent of the present invention comprises: (A) an alkoxyoligomer; (B) (1) a long-chain silicone oil whose viscosity is within the range of 50 cSt to 500,000 cSt, or (2) at least one type of silicone oil selected from a carbinol-modified silicone oil, a carboxyl-modified silicone oil, a polyether-modified silicone oil, and a fluoroalkyl-modified silicone oil, whose one or both terminals and/or one side chain include a functional organic group introduced; and (C) an organotitanium compound or an organoaluminum compound.

The surface modification treatment agent of the present invention is used as a coating liquid obtained by mixing and dissolving the above components and a diluent solvent, or by dispersing the same.

The coating liquid is coated on the surface of a base material and dried, or dried and then calcined to modify the surface of the base material so as to achieve lower tackiness and lower friction.

Use of the surface modification treatment agent of the present invention makes the surface mirror-finished, smaller recesses, and low friction. Consequently, no stain is retained in recesses.

<Alkoxyoligomer>

The alkoxyoligomer is a relatively low-molecular-weight resin both having an organic group and an alkoxysilyl group. Illustrative example of the organic group includes an alkyl group such as a methyl group; an aryl group such as a phenyl group; and an oligomer having an organic functional group such as an epoxy group and a mercapto group. Illustrative example of the alkoxy group includes a methoxy group and an ethyl group.

Particularly in the present invention, the organic group is preferably a methyl group, and the alkoxy group is preferably a methoxy group in view of reactivity to a base material and non-tackiness after calcination.

The methyl alkoxyoligomer, containing a methyl group as an organic group, is excellent in hydrolytic reactivity, and can readily be used as a normal temperature/humid curable coating agent by using some curing catalysts. The methyl alkoxyoligomer is also preferable because a curable film having high hardness excellent in abrasion resistance can be formed.

In contrast to a silane coupling agent, an alkoxyoligomer, containing many types of reactive functional groups, is excellent in adhesion and flexibility. The use of an alkoxyoligomer is preferable because the addition of a lubricating component causes no adhesion degradation.

The viscosity of an alkoxyoligomer in the present invention is preferably 5 to 120 cSt, and more preferably 20 to 100 cSt.

A smaller viscosity of an alkoxyoligomer normally leads to favorable non-tackiness after curing, but degraded flexibility as well. A larger viscosity can make the non-tackiness less favorable.

The viscosity of an alkoxyoligomer under 5 cSt is not preferable because of cissing on the coated surface and difficult formation of a uniform mirror-finished film.

The viscosity of an alkoxyoligomer over 120 cSt is not preferable because the compatibility with a silicone oil to be added degrades, and a solution or a coated surface cannot be uniform. Further, it is not preferable because the storage stability of a surface modification liquid also degrades and coating patterns are limited.

Illustrative preferable example of the alkoxyoligomer includes a commercial product such as “X-40-9225” (Product from Shin-Etsu Chemical Co., Ltd.).

<Catalyst>

Illustrative example of the catalyst (curing agent) used for an alkoxyoligomer includes titanium catalyst, aluminum catalyst, and phosphoric acid catalyst. In view of flex resistance and impact resistance, an organotitanium compound or an organoaluminum compound is employed in the present invention.

Illustrative example of the organotitanium compound includes tetrabutyl titanate and tetraisopropyl titanate.

Illustrative example of the organoaluminum compound includes aluminum triisopropoxide and aluminum trisecondary butoxide.

The amount of a catalyst is preferably within the range of 0.5 to 50 parts by weight, relative to the total 100 parts by weight of an alkoxyoligomer, and more preferably within the range of 1.0 to 10 parts by weight.

A larger amount of a catalyst to be used is not preferable because it leads to increased curing rate and improved non-tackiness, but causes loss of flexibility. On the contrary, a smaller amount of a catalyst to be used can generate the opposite trend. Consequently, the above range is preferable.

Illustrative preferable example of the catalyst includes a commercial product such as “D-20” (titanium catalyst) and “DX-9740” (aluminum catalyst) (Product from Shin-Etsu Chemical Co., Ltd.).

<Silicone Oil>

Silicone oils to be used can roughly be classified into two types: first and second silicone oils.

Illustrative example of the first silicone oil of the present invention includes a straight silicone oil whose viscosity is within the range of 50 to 500,000 cSt, preferably 50 cSt to 50,000 cSt, and more preferably 50 to 10,000 cSt.

The straight silicone oil of the present invention refers to a non-modified silicone oil whose main chain and/or a side chain include no functional organic group introduced.

Illustrative example of the straight silicone oil includes a dimethyl silicone oil, a methylphenyl a silicone oil, and a methyl hydrogen silicone oil.

Particularly in the present invention, a dimethyl silicone oil can preferably be used.

A higher viscosity leads to higher lubrication sustainability and increased compatibility with a binder, but an extremely high viscosity leads to less compatibility with a binder.

The viscosity under 50 cSt is not preferable because the lubricating property or non-tackiness leads to loss of sustainability or durability.

The viscosity over 500,000 cSt is not preferable because the compatibility with an alkoxyoligomer degrades, and coating with the silicone oil cannot be uniform.

Illustrative example of the second silicone oil of the present invention includes at least one type of silicone oil selected from a carbinol-modified silicone oil (a silicone oil having a phenolic OH group), a carboxy-modified silicone oil (a silicone oil having a carboxyl group), a polyether-modified silicone oil (a silicone oil having a polyether group), and a fluoroalkyl-modified silicone oil (a silicone oil having a fluoroalkyl group), whose one or both terminals and/or a side chain include a functional organic group introduced.

In the present invention, any silicone oil whose one or both terminals and/or a side chain include a functional organic group can be used.

In these modified silicone oils, in contrast to the above straight silicone oil, the scope of the viscosity is not restricted.

If modified silicone oils other than the above modified silicone oils are used, the coefficient of friction obtained cannot be low enough to be desired.

More preferable reactive silicone oil can be represented by the following general formula (1) or (2).

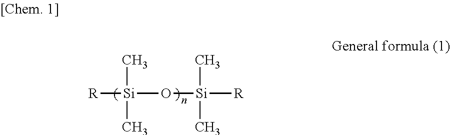

In the above general formula (1), each “R” represents —C₃H₆OC₂H₄OH, —OH, or —COOH, and “n” represents an integer of approximately 20 or less.

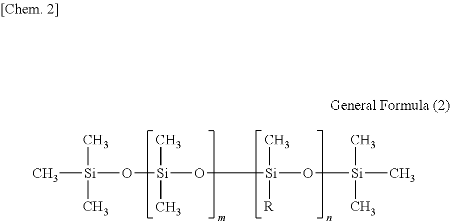

In the above general formula (2), “R” represents —C₃H₆OC₂H₄OH, —OH, —COOH, or —CH₂CH₂CF₃, “m” represents an integer of approximately 20 or less, and “n” represents an integer of approximately 20 or less.

Particularly preferable reactive silicone oil includes the silicone oil represented by the general formula (1), wherein each “R” represents —C₃H₆OC₂H₄OH, and particularly preferably “n” represents approximately 10.

A silicone oil having hydrogen bonded to silicon in a silicone skeleton can also be used.

Illustrative preferable example of the silicone oil includes a commercial product, such as “KF-96-50CS” (Product from Shin-Etsu Chemical Co., Ltd.) and “KF-96-10,000CS” (Product from Shin-Etsu Chemical Co., Ltd.) as a dimethyl silicone oil, and “X-22-160AS” (Product from Shin-Etsu Chemical Co., Ltd.) as a carbinol-modified silicone oil.

The amount of a silicone oil is preferably within the range of 0.3 to 30 parts by weight, relative to the total 100 parts by weight of an alkoxyoligomer, and more preferably within the range of 0.5 to 10 parts by weight.

The amount of a silicone oil under 0.3 parts by weight is not preferable because the coefficient of friction is high, wear resistance is not favorable, and tacking occurs.

The amount of a silicone oil over 30 parts by weight is not preferable because of degraded adhesion with a base material and degraded wear resistance from insufficient film strength.

In addition, the compatibility with a binder can be improved by raising the calcining temperature without using any modified silicone oil.

<Diluent Solvent>

Illustrative example of the diluent solvent includes a water type and an organic solvent type. A low-boiling-point solvent and a high-boiling-point solvent can be combined depending on the drying rate.

The diluent solvent is preferably within the range of 6 to 80 parts by weight, relative to the total 100 parts by weight of an alkoxyoligomer, and more preferably 30 to 70 parts by weight. A lower solid concentration causes dripping during coating, thereby reducing the drying rate. A higher concentration makes it difficult to control the rough texture and thickness of a coated surface.

Illustrative preferable example of the diluent solvent includes the organic solvent such as methyl ethyl ketone (MEK), methyl isobutyl ketone (MIBK), tetrahydrofuran (THF), acetone, ethyl acetate, butyl acetate, toluene, xylene, heptane, cyclohexanone, and isophorone.

2. Base Material to be Modified with Surface Modification Treatment Agent

Illustrative example of the base material to be modified with the surface modification treatment agent of the present invention includes: a rubber material such as a silicone rubber, a fluororubber and so on; a resin material; a metal material such as stainless; and a concrete material. If a coating layer is formed on each of these base materials, the coating surface is also contained in the base material.

3. Pressing Roller for Image Forming Apparatus According to the Present Invention

Illustrative example of the member for an image forming apparatus that can desirably employ the surface modification treatment agent of the present invention includes a pressing roller.

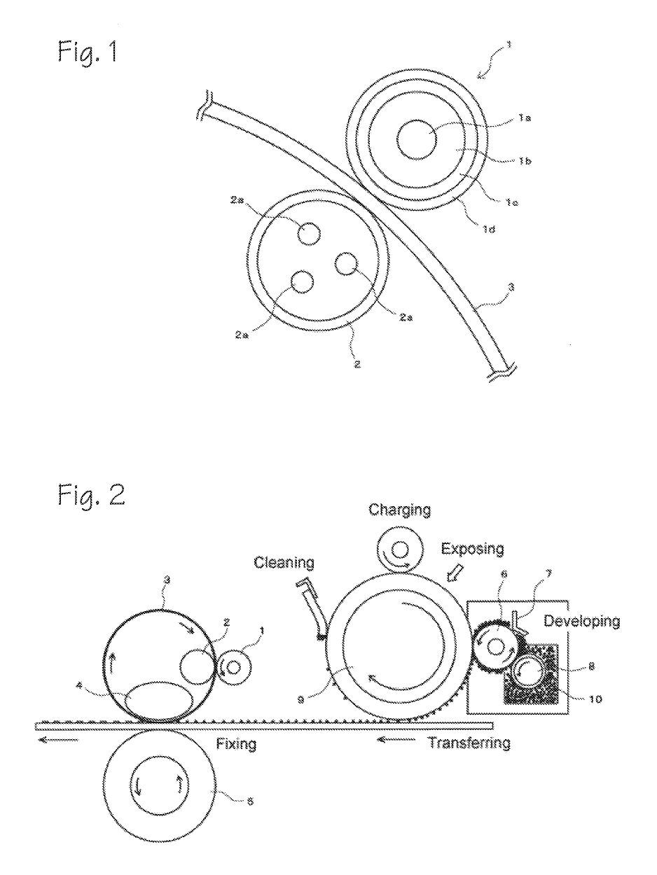

FIG. 1 is a cross-sectional view showing one example of main parts of a pressing roller in a toner fixing mechanism used in the present invention.

FIG. 2 is a schematic diagram showing one example of a developing device by means of a member for an image forming apparatus of the present invention.

The pressing roller 1 of the present invention refers to a roller used to pressurize and heat a fixing belt 3 in a developing process of a developing device. This developing process allows the fixing belt 3 and a pressure roller 5 to melt and fix with heat and pressure a toner which has been transferred to the paper.

Specifically, the above process is based on a structure for pressurizing and directly heating the fixing belt 3 by sandwiching the fixing belt 3 between the pressing roller 1 and a heating roller 2 just before feeding paper. The pressing roller 1 is disposed so as to be brought into contact with the heating roller 2 through the fixing belt 3.

The heating roller 2 is not particularly restricted in structure so long as it is designed to be heated, and it can be embodied by a known method. For example, a heat source such as a heater may be placed inside a metal tubular roller to heat a heating roller itself.

Accordingly, such a structure for sandwiching a fixing belt between a pressing roller and a heating roller can provide a smaller heating mechanism of a fixing belt to reduce the power for heating and increase the heating rate.

A pressing roller coated with the surface modification treatment agent of the present invention can form non-tacky coating films to obtain the surface of the pressing roller excellent in non-tackiness and low friction.

FIG. 1 shows one example of the pressing roller 1 for an image forming apparatus capable of achieving the present invention. According to the present invention, a rubber base material layer lb is formed around a core material la, and a metal layer lc is formed around the rubber base material layer lb, on which a covering layer ld is formed with a surface modification treatment agent.

One example of a pressing roller for an image forming apparatus capable of achieving the present invention is also shown. A rubber base material layer is coated and formed around a core material, and a metal layer is then formed on the rubber base material layer, on which a surface modification treatment agent is coated, dried and calcined to obtain a covering layer.

The surface modification treatment agent (coating liquid) is coated and dried on a base material surface, or dried and further calcined to modify the surface of the base material so as to achieve lower tackiness and lower friction.

Illustrative example of the coating method includes, but not specifically restricted to, a known coating method such as dipping method, spraying method, roll coat method, doctor blade method, and flow coat method.

Drying conditions may be determined accordingly, but preferably drying may be performed from room temperature to 150° C. for 5 to 20 minutes.

A calcination process may be eliminated, but it is preferably performed from room temperature to 250° C. for 5 to 120 minutes. It can be set depending on the heat resistance of a base material.

The coating (covering layer) thickness is preferably 1 to 8 μm, and more preferably 2 to 6 μm.

The coating thickness under 1 μm is not preferable because the covering layer is not fitted into irregularities of a base material surface, lower friction is hard to achieve, and the wear resistance degrades.

The coating thickness over 8 μm is not preferable because the covering layer shows cracks, and folding can generate cracks or peeling.

A rubber base material layer and a metal layer are preferably formed of a rubber base material and metal, respectively, which are the same materials as a fixing belt.

Illustrative example of the rubber base material includes, but not specifically restricted to, a silicone rubber and a fluororubber.

In the present invention, a silicone rubber is preferably employed due to low hardness and less fatigue.

Illustrative preferable example of the metal layer includes a metal excellent in thermal conductivity such as Ni electroforming disclosed in JP-A-2706432 and JP-A-4318909.

A metal such as Ni electroforming is preferable because it is excellent in thermal conductivity and durability during a high-temperature thermal cycle.

Illustrative example of an additive which may be added to a rubber base material layer, as required, includes a conductive agent, a filler, an extender, a reinforcing agent, a processing aid, a curing agent, a vulcanizing accelerator, a crosslinker, a crosslinking agent, an antioxidant, a plasticizer, a UV absorber, a pigment, a silicone oil, a process aid, and a surfactant.

Illustrative example of the conductive agent includes a known one such as an ionic conductive agent and an electronic conductive agent.

Illustrative example of the ionic conductive agent includes a salt of the first group metal of the Periodic Table such as LiCF₃SO₃, NAClO₄, LiClO₄, LiAsF₆, LiBF₄, NaSCN, KSCN, and NaCl; an ammonium salt such as NH₄Cl, (NH₄)₂SO₄, and NH₄NO₃; a salt of the second group metal of the Periodic Table such as Ca(ClO₄)₂ and Ba(ClO₄)₂; a complex of these salts, polyvalent alcohol such as 1,4-butanediol, ethylene glycol, polyethylene glycol, propylene glycol, and polypropylene glycol, and these derivatives; a complex of these salts and a monol of ethylene glycol monomethyl ether, ethylene glycol monoethyl ether, polyethylene glycol monomethyl ether, polyethylene glycol monoethyl ether; a cationic surfactant such as a quaternary ammonium salt; an anionic surfactant such as aliphatic sulfonate, alkyl sulfate ester salt, and alkyl phosphate ester salt; and an amphoteric surfactant of betaine.

Illustrative example of the electronic conductive agent includes a carbonaceous substance such as a carbon black and a graphite; a metal or an alloy such as aluminum, silver, gold, a tin-lead alloy, and a cupper-nickel alloy; a metal oxide such as a zinc oxide, a titanium oxide, an aluminum oxide, a tin oxide, an antimony oxide, an indium oxide, and a silver oxide; and a substance obtained by performing conductive metal plating such as copper, nickel, and silver on each filler.

Conductive agents, including the above ionic conductive agent and electronic conductive agent, can be used in the form of powder or fiber alone or by mixing two or more types. In particular, carbon black can preferably be used due to easy control of conductivity and economical advantage.

### EXAMPLE

Examples of the present invention will be described. The scope of the present invention is not restricted thereto.

### Example 1

<Preparation of Surface Modification Treatment Agent>

alkoxyoligomer (amount of alkoxy group: 24 wt %) (″X-40-
9225,″ Product from Shin-Etsu Chemical Co.,
Ltd.) . . . 100 parts by weight
titanium catalyst (″D-20,″ Product from Shin-Etsu
Chemical Co., Ltd.) . . . 2.0 parts by weight
OH-modified silicone oil (″X-22-160AS,″ Product from Shin-
Etsu Chemical Co., Ltd.) . . . 4.2 parts by weight
diluent solvent; methyl ethyl ketone . . . 50 parts by weight

The above components were mixed to prepare a surface modification treatment agent.

<Preparation of Pressing Roller>

A silicone rubber base material layer was formed around a core material, and then a Ni electroforming laminated body was formed, and a surface modification treatment agent was spray-coated on the Ni electroforming surface to calcine the same 10 minutes after air drying. The thickness of a surface-modified covering layer was 2 to 3 μm.

<Preparation of Metal Laminate>

Similarly, a SUS301 steel plate 0.2 mm thick was spray-coated and calcined to prepare a test piece of metal laminate.

<Evaluation Method>

The above test piece of metal laminate was evaluated in the following items. The results are shown in Table 1.

(1) Coefficient of Dynamic Friction

Using a surface property tester, “HEIDON TriboGear” (Product from Shinto Scientific Co., Ltd.) according to ASTM D-1894 (JIS K71 25: 1999, P 8147, ISO8295: 1995), the surface of a steel plate 2 mm thick was spray-coated with a surface modification treatment agent obtained above and calcined so as to have the thickness of 2 to 3 μm to measure the coefficient of dynamic friction. The results are shown in Table 1.

### (Test Conditions)

Material to be tested: SUS304 steel ball 10 mm in diameter
Traveling speed: 50 mm/min

### Load: 0.49N

### Amplitude: 50 mm

(2) Adhesion Evaluation by Cross Cut Test

Using a test piece of metal laminate obtained, according to JIS K5600-5-6: 1999 (ISO2409: 1992), a tape peel test was conducted after a cross cut test to evaluate the adhesion based on the following standards. The results are shown in Table 1.

### <Evaluation Standards>

Good: Coating film of bend is not peeled, and cut line has no ruffles.
Bad: Coating film of bend is peeled.
Since a coating film of a bend peeled is not preferably used as a member for an image forming apparatus, it can be evaluated as bad.

(3) Flexibility Evaluation by Flex Test

Using a test piece of metal laminate obtained, according to JIS K5600-5-1: 1999 (ISO1519: 1973), a flex resistance test was conducted (with a mandrel 5 mm in diameter) to visually confirm whether the surface color turns white and whether any crack is found on a sheet (covering layer) by microscope based on the following standards. The results are shown in Table 1.

### <Evaluation Standards>

Good: Coating film shows no crack, and no color change is found.
Bad: Coating film shows large crack, and color change is found.
Since a coating film of a bend having any crack and color change (coating film is warped) is not preferably used as a member for an image forming apparatus, it can be evaluated as bad.

(4) Nail-Scratching

Using a test piece of metal laminate obtained, the surface of a coating film was scratched with nail 50 times to confirm whether the film is peeled.

(5) Wear Resistance Test (Reciprocating Test)

Using a test piece of metal laminate obtained, a test was conducted with a surface property tester, HEIDON TriboGear (Product from Shinto Scientific Co., Ltd.) based on the following conditions to confirm whether the coating film shows peeling or wear.

(Test conditions)
Material to be tested: SUS304 steel ball 10 mm in diameter
Traveling speed: 400 mm/min

### Load: 0.49N

Oscillation: 30 mm, 500 times

### Example 2

The test conditions were the same as the Example 1, except that an OH-modified silicone oil was replaced with a dimethyl silicone oil (“KF-96-50CS,” Product from Shin-Etsu Chemical Co., Ltd.: viscosity; 50 cSt) in the Example 1 to obtain a surface modification treatment agent.

### Example 3

The test conditions were the same as the Example 1, except that an OH-modified silicone oil was replaced with a dimethyl silicone oil (“KF-96-10,000CS,” Product from Shin-Etsu Chemical Co., Ltd.: viscosity; 10,000 cSt) in the Example 1 to obtain a surface modification treatment agent.

### Example 4

The test conditions were the same as the Example 1, except that 4.2 parts by weight of an OH-modified silicone oil was replaced with 0.5 parts by weight of a dimethyl silicone oil (“KF-96-10,000CS,” Product from Shin-Etsu Chemical Co., Ltd.: viscosity; 10,000 cSt) in the Example 1 to obtain a surface modification treatment agent.

### Example 5

The test conditions were the same as the Example 1, except that 4.2 parts by weight of an OH-modified silicone oil was replaced with 0.5 parts by weight of a dimethyl silicone oil (“KF-96-10,000CS,” Product from Shin-Etsu Chemical Co., Ltd.: viscosity; 10,000 cSt) in the Example 1 and the calcining conditions at 150° C. for 30 minutes were replaced with those at 230° C. for 30 minutes to obtain a surface modification treatment agent.

### Comparative Example 1

The test conditions were the same as the Example 1, except that an OH-modified silicone oil was replaced with an amine-modified silicone oil (“KF-393,” Product from Shin-Etsu Chemical Co., Ltd.) in the Example 1 to obtain a surface modification treatment agent.

### Comparative Example 2

The test conditions were the same as the Example 1, except that 4.2 parts by weight of an OH-modified silicone oil was replaced with 0 part by weight thereof in the Example 1 to obtain a surface modification treatment agent.

### Comparative Example 3

The test conditions were the same as the Example 1, except that 2.0 parts by weight of a titanium catalyst was replaced with 100 parts by weight of a silane coupling agent (“APZ-6633,” Product from Dow Corning Toray Co., Ltd.), 4.2 parts by weight of an OH-modified silicone oil was replaced with 0 part by weight thereof and 50 parts by weight of methyl ethyl ketone was replaced with 0 part by weight thereof in the Example 1 to obtain a surface modification treatment agent.

### Comparative Example 4

The test conditions were the same as the Example 1, except that 100 parts by weight of an alkoxyoligomer and 2.0 parts by weight of a titanium catalyst were replaced with 100 parts by weight of a silane coupling agent (“APZ-6633,” Product from Dow Corning Toray Co., Ltd.), 4.2 parts by weight of an OH-modified silicone oil was replaced with 0.33 parts by weight of a dimethyl silicone oil (“KF-96-10,000CS,” Product from Shin-Etsu Chemical Co., Ltd.: viscosity; 10,000 cSt) and 50 parts by weight of methyl ethyl ketone was replaced with 0 part by weight thereof in the Example 1 to obtain a surface modification treatment agent.

### Comparative Example 5

The test conditions were the same as the Example 1, except that 100 parts by weight of an alkoxyoligomer and 2.0 parts by weight of a titanium catalyst were replaced with 100 parts by weight of an alkoxysilane (“Nano Glasscoat SV9000,” Product from Nano Glasscoat JAPAN), 4.2 parts by weight of an OH-modified silicone oil was replaced with 0 part by weight thereof and 50 parts by weight of methyl ethyl ketone was replaced with 0 part by weight thereof in the Example 1 to obtain a surface modification treatment agent.

TABLE 1
Unit: parts by weight

| | | | | | | | Com- | Com- | Com- | Com- | Com- |
|---|---|---|---|---|---|---|---|---|---|---|---|
| | | | | | | | parative | parative | parative | parative | parative |
| | | Example | Example | Example | Example | Example | Ex- | Ex- | Ex- | Ex- | Ex- |
| | | 1 | 2 | 3 | 4 | 5 | ample 1 | ample 2 | ample 3 | ample 4 | ample 5 |
| Binder | Alkoxyoligomer | 100 | 100 | 100 | 100 | 100 | 100 | 100 | | | |
| component | Titanium | 2.0 | 2.0 | 2.0 | 2.0 | 2.0 | 2.0 | 2.0 | | | |
| | catalyst | | | | | | | | | | |
| | Silane | | | | | | | | 100 | 100 | |
| | coupling | | | | | | | | | | |
| | agent | | | | | | | | | | |
| | (aminosilane. | | | | | | | | | | |
| | vinylsilane) | | | | | | | | | | |
| | Nano Glasscoat | | | | | | | | | | 100 |
| | (alkoxysilane) | | | | | | | | | | |
| Lubricating | OH-modified | 4.2 | | | | | | — | — | | — |
| component | Si oil | | | | | | | | | | |
| | Dimethyl | | 4.2 | | | | | | | | |
| | silicone oil | | | | | | | | | | |
| | (50cSt) | | | | | | | | | | |
| | Dimethyl | | | 4.2 | 0.5 | 0.5 | | | | 0.33 | |
| | silicone oil | | | | | | | | | | |
| | (10,000cSt) | | | | | | | | | | |
| | Amine- | | | | | | 4.2 | | | | |
| | modified | | | | | | | | | | |
| | Si oil | | | | | | | | | | |
| Diluent | MEK | 50 | 50 | 50 | 50 | 50 | 50 | 50 | — | — | — |
| solvent | | | | | | | | | | | |

| | | | | | | | | | | |
|---|---|---|---|---|---|---|---|---|---|---|
| Calcination condition | 150° C. | 150° C. | 150° C. | 150° C. | 150° C. | 150° C. | 150° C. | 150° C. | 150° C. | 150° C. |
| | 30 min | 30 min | 30 min | 30 min | 30 min | 30 min | 30 min | 30 min | 30 min | 30 min |
| Coefficient of | 0.13 | 0.06 | 0.01 | 0.03 | 0.02 | 0.44 | 1.11 | 0.72 | 0.07 | 0.03 |
| dynamic friction | | | | | | | | Crack | Crack | |
| | | | | | | | | found | found | |
| Evaluation of adhesion | Good | Good | Good | Good | Good | Good | Good | Good | Good | Good |
| Evaluation of flexibility | Good | Good | Good | Good | Good | Good | Good | Good | Good | Good |
| by Flex test | | | | | | | | | | |
| Nail-scratching | None | None | None | None | None | None | None | None | Found | None |
| Reciprocating test | 500 times, | 600 times. | 500 times, | 500 times, | 500 times, | 500 times, | 500 times. | 500 times, | 10 times, | 70 times, |
| | no wear, | no wear, | no wear, | no wear, | no wear, | no wear, | no wear, | no wear, | wear | wear |
| | no crack | no crack | no crack | no crack | no crack | no crack | no crack | no crack | found | found |

1: Pressing roller
la: Core material
lb: Rubber base material layer
lc: Metal layer
ld: Covering layer
2: Heating roller
2a: Heater
3: Fixing belt
4: Fixing pad
5: Pressure roller
6: Developing roll
7: Regulating blade
8: Supply roll
9: Photoreceptor
10: Toner

We claim:

1. A surface modification treatment agent comprising:
(A) an alkoxyoligomer;
(B) (1) a long-chain silicone oil whose viscosity is within the range of 50 cSt to 500,000 cSt, or
(2) at least one type of silicone oil selected from a carbinol-modified silicone oil, a carboxyl-modified silicone oil, a polyether-modified silicone oil, and a fluoroalkyl-modified silicone oil, whose one or both terminals and/or a side chain include a functional organic group introduced; and
(C) an organotitanium compound or an organoaluminum compound.

2. A member for an image forming apparatus, the surface of the member being modified with the surface modification treatment agent according to claim 1.

3. The member for an image forming apparatus according to claim 2, wherein the coefficient of friction is 0.15 or less.

4. The member for an image forming apparatus according to claim 2 or 3, wherein the member for an image forming apparatus is a pressing roller.

5. A toner fixing mechanism, comprising: the pressing roller according to claim 4; a fixing belt; and a heating roller, wherein the pressing roller is disposed so as to be brought into contact with the heating roller through the fixing belt.
